(19) United States
(12) Patent Application Publication
(10) Pub. No.: US 2005/0289046 A1
(43) Pub. Date: Dec. 29, 2005

(54) System and method for facilitating realtor-assisted loan shopping and origination

(76) Inventor: Howard H. Conyack JR., Hackettstown, NJ (US)

Correspondence Address: KAPLAN GILMAN GIBSON & DERNIER L.L.P., 900 ROUTE 9 NORTH, WOODBRIDGE, NJ, 07095, US

(21) Appl. No.: 11/174,440

(22) Filed: Jul. 1, 2005

Related U.S. Application Data
(63) Continuation-in-part of application No. 09/777,179, filed on Feb. 5, 2001.
(60) Provisional application No. 60/180,013, filed on Feb. 3, 2000.

(51) Int. Cl. G06F 17/60

(52) U.S. Cl. 705/38

(57) ABSTRACT

An interactive Internet mortgage origination system and method for business-to-business use with selected point of access professionals. The system allows professionals, such as Realtors, builders, accountants, lawyers, insurance agents, financial planners, and other professionals already in close proximity to the mortgage transaction to actively participate in the transaction. The system allows the Realtors to track the loan origination progress for multiple borrowers from active to approved to floating to locked to closed. The mortgage origination system also allows the Realtor to monitor commission pipelines generated thereby. The pipeline monitor is helpful in tracking all active, approved, floating, locked, and closed mortgage applications. The mortgage origination system also will track the relationship of a branch manager, or broker, with the real estate agents, or solicitors, who work for that branch manager.

### RELATED APPLICATIONS

This application is a continuation-in-part of co-pending application Ser. No. 09/777,179 filed Feb. 5, 2001, which claims benefit of provisional application No. 60/180,013 filed Feb. 3, 2000. The entirety of both applications is incorporated herein by reference.

### FIELD OF THE INVENTION

This invention pertains generally to computerized information management and processing systems. More specifically, this invention relates to a system and method for Realtor-assisted loan shopping and origination.

### DESCRIPTION OF RELATED ART

In today's loan origination industry, Realtors do not earn a commission from a mortgage origination transaction. Although Realtors, in particular, incur the time and economic costs of developing and generating a real estate sale, they do not realize profits from lucrative financial transactions that are always on their desk, the mortgage origination transaction. Whether traditional or direct to the consumer, mortgage banking simply leaves out the Realtor. In fact, the Realtor often supplies the referral of a mortgage broker to the borrower, which eventually results in the loan. Thus, Realtors and other professionals close to the mortgage origination transaction want and need a method of originating mortgages themselves on behalf of a borrower.

In addition to the desires of these Realtors, there is growing evidence that consumers would prefer one-stop shopping for homes and mortgages from a single professional entity. For example, the borrower benefits by Realtor involvement during the pre-qualification and origination stages. Knowledge of the mortgage process could help the Realtor tailor the focus of their search efforts on affordable homes within the borrower's pre-qualified range. This increases the Realtor's efficiency by reducing the number of unjustified visits to show homes far outside of their client's means and reduces the number of broken sales caused by borrowers attempting to purchase homes outside of their qualification range.

Unfortunately, adding a new service or feature outside of the traditional scope of service provided by a professional, as in a Realtor assisting with loan origination, can be a very difficult process. Until recently, several obstacles have prevented Realtors from participating in the mortgage origination process. For example, Federal regulations, such as the Real Estate Settlement & Procedures Act (RESPA), have prohibited Realtors from earning any more than a minimal finder's fee taken from the origination revenues. Although current RESPA guidelines permit a Realtor to be paid as a traditional loan officer, the Realtor must first be employed by a mortgage company and second perform various specific services in relation to the mortgage transaction when taking a mortgage application from a borrower. There are fourteen specific services outlined in the RESPA HUD Statement of Policy. Presently, in order for a Realtor to be in RESPA compliance while originating mortgages, the realtor must comply with five of the fourteen outlined services. In addition to RESPA compliance, some states have specific compliance points that must be recognized during authorization, application, and loan processing. The difficulty of properly learning the relevant state and federal regulations prevents many Realtors from assisting their client's with mortgage origination.

Additionally, information on effectively processing and selling a mortgage is not easily acquired nor understood. Furthermore, once acquired, this information must be maintained daily as the mortgage market is in a continual state of flux. Moreover, the Realtor must not neglect his or her primary duty, i.e., to maintain a good understanding of the real estate market. What is needed is a system or method that simplifies the mortgage origination process for the Realtor while ensuring compliance with the relevant regulations.

### BRIEF DESCRIPTION OF THE DRAWINGS

Embodiments of the invention are described and explained with additional specificity and detail through the use of the accompanying drawings in which:

FIG. 1 illustrates an exemplary system that provides a suitable operating environment for the present invention;

FIG. 2 is a schematic block diagram of physical components of a mortgage origination system including the processing center and web system;

FIG. 3 is a dataflow block diagram of a mortgage origination system including the processing center and web system;

FIG. 4 illustrates a screen interface of an exemplary Login page;

FIG. 5 is a screen interface of an exemplary system “Home” page;

FIG. 6 is a screen shot of an exemplary “Authorize” page;

FIG. 7 is a screen shot of an exemplary “Consult” page;

FIG. 8 is a screen shot of an exemplary “Qualify” page;

FIG. 9 is a screen shot of an exemplary state-specific “Apply” page;

FIG. 10 is a screen shot of an exemplary loan status “Monitor” page;

FIG. 11 is a screen shot of an exemplary borrower “Personal Information” page;

FIG. 12 is a screen shot of an exemplary dynamic borrower “Credit & Financials” information page;

FIG. 13 is a screen shot of an exemplary “Subject Property Information” page;

FIG. 14 is a screen shot of an exemplary “Loan Options” page;

FIG. 15 is a screen shot of an exemplary “Qualifying Programs” page;

FIG. 16 is a screen shot of an exemplary “Borrower Service Center” loan program details page;

FIG. 17 is a screen shot of an exemplary “Client Summary” page;

FIG. 18 is a screen shot of an exemplary “Pre-Approval Letter” page;

FIG. 19 is a screen shot of an exemplary “Good Faith Estimate” page;

FIG. 20 is a screen shot of an exemplary “Credit Card Approval” payment information page;

FIG. 21 is a screen shot of an exemplary online Uniform Residential Loan Application page;

FIG. 22 is a screen shot of an exemplary “Borrower Service Center” loan status page; and

FIG. 23 is a screen shot of an exemplary “Pipelines” closed page.

### DETAILED DESCRIPTION OF THE PREFERRED EMBODIMENTS

The present invention has been developed in response to the current state of the art, and in particular, in response to these and other problems and needs that have not been fully or completely solved by currently available systems or techniques. The present invention provides an interactive Internet mortgage origination system for business-to-business use via selected point-of-access professionals. The system allows professionals already in close proximity to the mortgage loan transaction to actively participate in the transaction. This is accomplished by replacing the traditional loan originator with an interactive mortgage origination system that is monitored by the professional, thereby allowing the professional to offer a one-stop shop to their client and earn additional fees for closely allied services. Reference throughout this specification to “Realtor” or “professional” means an individual close to a mortgage origination transaction who can participate in the mortgage commission distribution, such as Realtors, real estate agents, real estate brokers, solicitors, builders, accountants, financial planners, insurance agents, lawyers, and other point-of-access professionals not directly associated with mortgage origination.

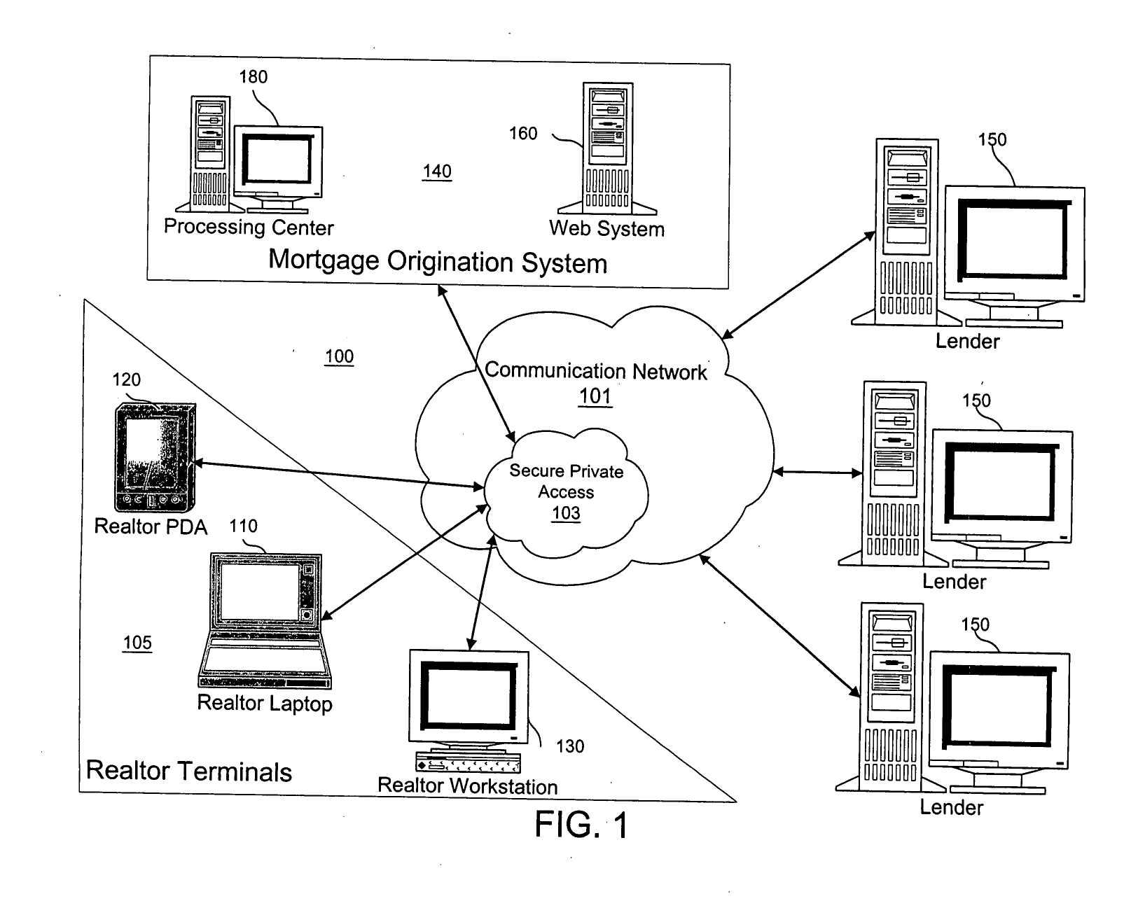

FIG. 1 and the following discussion are intended to provide a brief general description of a suitable computing environment in which the invention may be implemented. Those skilled in the art will appreciate that the invention may be practiced with many types of computer system configurations, including personal computers, hand-held devices, Personal Digital Assistants (PDA), multi-processor systems, microprocessor-based or programmable consumer electronics, network PCs, minicomputers, and the like.

Furthermore, the particular features, structures, or characteristics may be combined in any suitable manner in one or more embodiments. In the following description, numerous specific details are provided, such as examples of programming, web pages, user selections, network transactions, database queries, database structures, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Accordingly, a system and method built in accordance with the present invention provides selected point-of-access professionals with a step-by-step mortgage origination process for borrowers. In one embodiment, the step-by-step process for mortgage origination includes: (1) authorize, (2) consult, (3) qualify, (4) apply, and (5) monitor.

One embodiment of the present invention provides dynamic direction to the select point-of-access professionals originating loans customized for the specific borrower they represent. The system dynamically changes requested data entry fields based in part on borrower information and type of loan application requested. A database concerning regulatory compliance allows the Realtor to ensure that necessary state and federal laws are followed, while also maintaining desired mortgage loan information, such as available commissions and interest rates, in an up-to-date and accurate database.

Yet another embodiment of the present invention provides interactive services and forms via a processing center and a borrower service center with which the Realtor performs specific functions like mortgage qualification, application, and status monitoring. These services may be accomplished through online forms, online documents, online calculators, online help, and online status and commission pipelines. Specifically, the invention allows the Realtor to access mortgage processing status and associated commission information, based in part on the actual processing of borrower mortgage applications by the processing center.

Referring now to FIG. 1, there is shown an exemplary system 100 or environment for delivering loan or mortgage programs, including specific qualifications, pricing analytics, and supplemental consultative content, to one or more agents, such as Realtors. FIG. 1 is intended to be illustrative of potential systems that may utilize the present invention and is not to be construed as limiting. The system of FIG. 1 illustrates various Realtor terminals 105, such as laptop 110, PDA 120, and workstation 130. In one embodiment, each terminal is configured to connect with a mortgage origination system 140 via a secure private access connection 103 within communication network 101. In another embodiment, one or more Lender servers and Realtor terminals communicate with mortgage origination system 140 via the communication network 101. The network 101 is preferably coupled to a plurality of Lender servers 150 for collecting and generating loan program information, such as interest rates, qualification requirements, and approval status to the mortgage origination system 140. The mortgage origination system 140 includes a loan processing center 180 and web system 160 for filtering the collected data from the borrowers against the guidelines provided by the lenders.

The communication network 101 is preferably a global information network, such as the Internet, which virtually eliminates the cost of software distribution. Implementing Internet standard technologies assures platform independence and secure data transmissions for the product. The Internet is a “network of networks” and is well known to those skilled in the art Communication over the Internet is accomplished using standard protocols, such as TCP/IP (transmission control protocol/Internet protocol) and the like. Use of the Internet provides the system 100 with robust functionality, expandability, and ease of maintenance. However, other networks are contemplated, examples of which include cable, satellite, telephone, power grid, or the like.

The secure private access 103 of the present invention optionally employs several layers of security features, in order to provide security to financial information that is a concern for customers. For example, in one embodiment, the mortgage origination system 140 utilizes Microsoft® Internet Information Server (IIS) software that maintains individual session states using built in session handling. Furthermore, a proxy server provides a complete set of firewall tools that provide protection against intrusion. Finally, the entire site utilizes Secure Sockets Layer (SSL) encryption technology, optionally employing 128-bit encryption. In one embodiment, external non-web access to the current network servers can be accomplished via a Virtual Private Network (VPN) connection utilizing Point-To-Point Tunneling Protocol (PPTP).

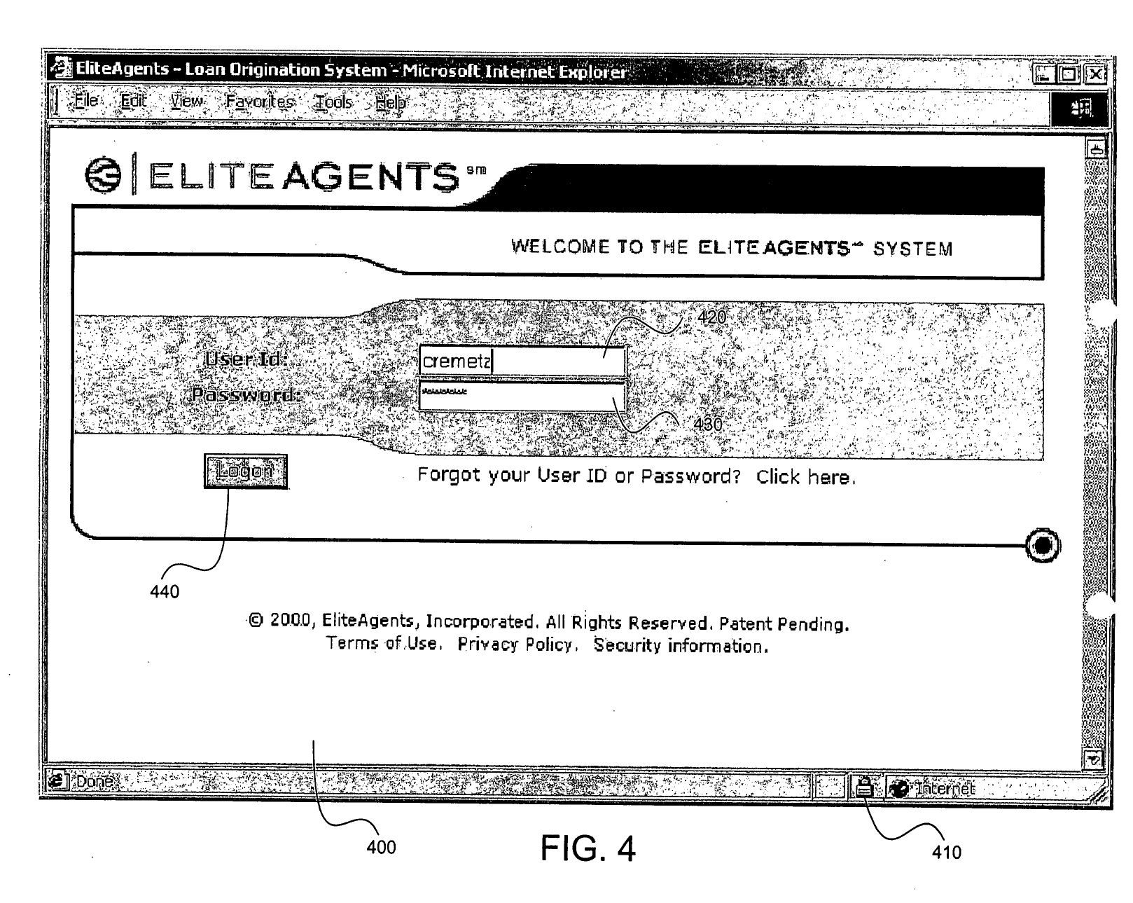

Under the present invention, Realtors are paid as a traditional loan officer. To receive a commission, the Realtor, employed by a mortgage company, must perform specific services. For example, Federal regulations outline fourteen specific services to be performed by the Realtor for and on behalf of the prospective borrower. Under the RESPA HUD Statement of Policy, a Realtor must comply with five of the fourteen outlined services in addition to taking a mortgage application from the borrower to be in RESPA compliance while originating mortgages. As will be illustrated in greater detail throughout the detailed description of FIGS. 4 through 23, the present invention allows a Realtor to actively comply with six of the fourteen services including: (1) taking information from the borrower and filling out the application; (2) analyzing the prospective borrower's income and debt in order to pre-qualify the borrower and determine the maximum mortgage that the prospective borrower can afford; (3) educating the prospective borrower in the home buying and financing process, advising the borrower about the different types of mortgage products available, and demonstrating how closing costs and monthly payments could vary under each product; (4) providing disclosures (truth in lending, good faith estimate and others) to the borrower, (5) assisting the borrower in understanding and clearing credit problems; and (6) maintaining regular contact with the borrower, realtor, and lender between application and closing to apprise them of the status of the application and to gather any additional information as needed.

During the mortgage processing stage, the present invention helps the Realtor to comply with the following seven of the fourteen services: (1) collecting financial information (tax returns, bank statements) and other related documents that are part of the application process; (2) initiating/ordering verifications of employment and verifications of deposits; (3) initiating/ordering requests for mortgage and other loan verifications; (4) initiating/ordering appraisals; (5) ordering legal documents; (6) determining whether the property was located in a flood zone or ordering such service; and (7) initiating/ordering inspections or engineering reports.

The final point of the fourteen services, participating in the mortgage closing, is normally performed during the regular duties of the Realtor or professional. Thus, the present invention assists the professional in complying with the fourteen service requirements of RESPA.

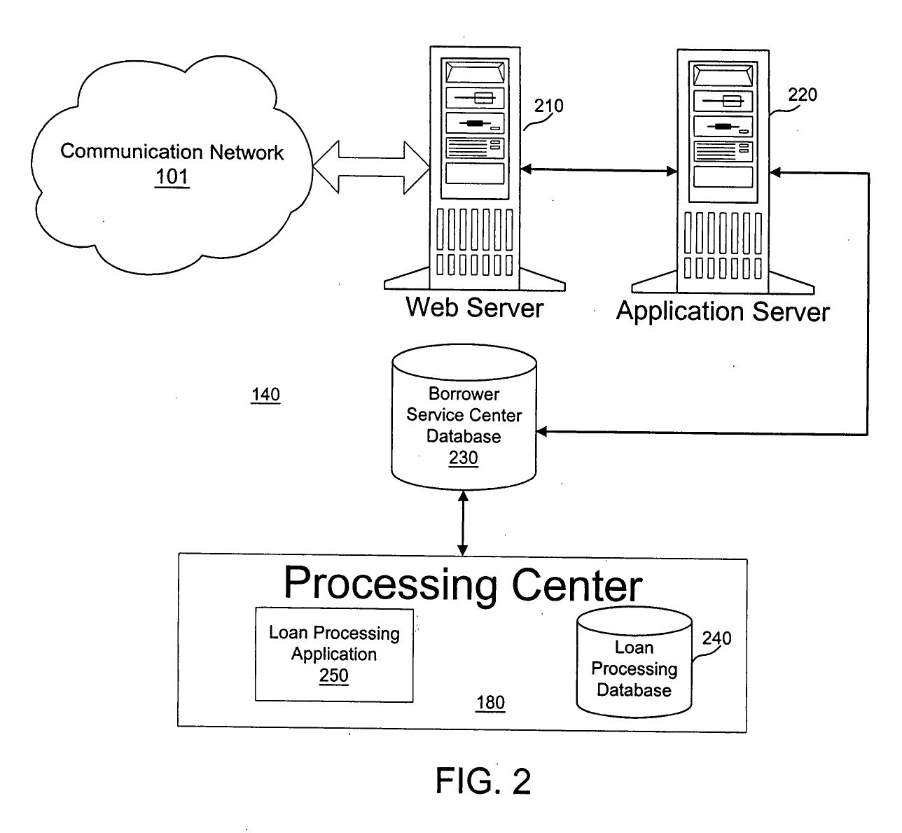

FIG. 2 is a schematic block diagram of physical components of a mortgage origination system 140. A web server 210 provides scalable functionality to manage the communications protocols with the communication network 101. In general, the web server 210 ensures an integration of Internet technologies allowing diverse sources to exchange information across the Internet. One example of a web server is Microsoft® Windows 2000 Server.

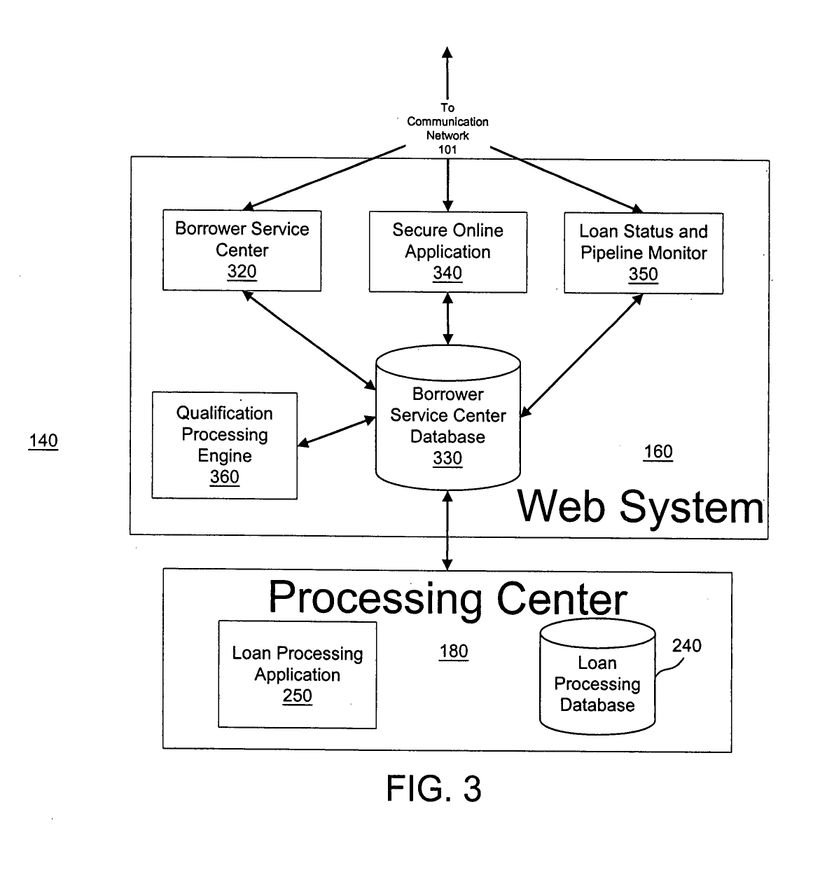

The Application Server 220 provides scalable functionality to process the business rules supporting the mortgage origination system 140. These proprietary business rules include the Borrower Service Center program module and Qualification Processing Engine program module, which are described in more detail in FIG. 3. Examples of the possible technologies used in the Application Server include Microsoft® Active Server Pages (ASP) and Microsoft® Component Object Modules (COM).

The Borrower Service Center Database 230 provides scalable functionality to process all data input and output requirements. All data associated with a users session is maintained within this database including user, borrower, loan and associated employee information. The proprietary architecture of this entity provides fast, scalable and reliable data retrieval. An example of the Borrower Service Center Database implementation would be Microsoft® SQL Server 2000.

Those skilled in the art will appreciate that the invention may be practiced with many types of server configurations. For example, although depicted as single machines, each entity 210, 220, and 230 could encompass several servers, which dynamically balance the load of processing requirements.

Processing Center 180 provides the functionality to process loans. To support the loan processing, loan processors utilize a loan processing application 250 to facilitate tracking the information associated with the loans as well as the processing state of the loan. Examples of the loan processing application 250 include Contour® Loan Handler or the Calyx® Point System. In general, loan processing application 250 will store data associated in a loan processing database 240. This data storage facility provides an electronic means to access and transfer loan origination data within the processing center 180 and to/from the Borrower Service Center Database 230.

FIG. 3 is a dataflow block diagram of an exemplary mortgage origination system 140 including processing center 180 and web system 160. Web system 160 includes a borrower service center 320, which is the hub by which the Realtor manages his or her client base of prospective borrowers. All of a Realtor's borrowers may be entered and maintained in this section. To begin using the borrower service center 320 the Realtor must create or select a borrower. Once a borrower has been selected, the borrower service center 320 operates in two modes; pre- and post-application.

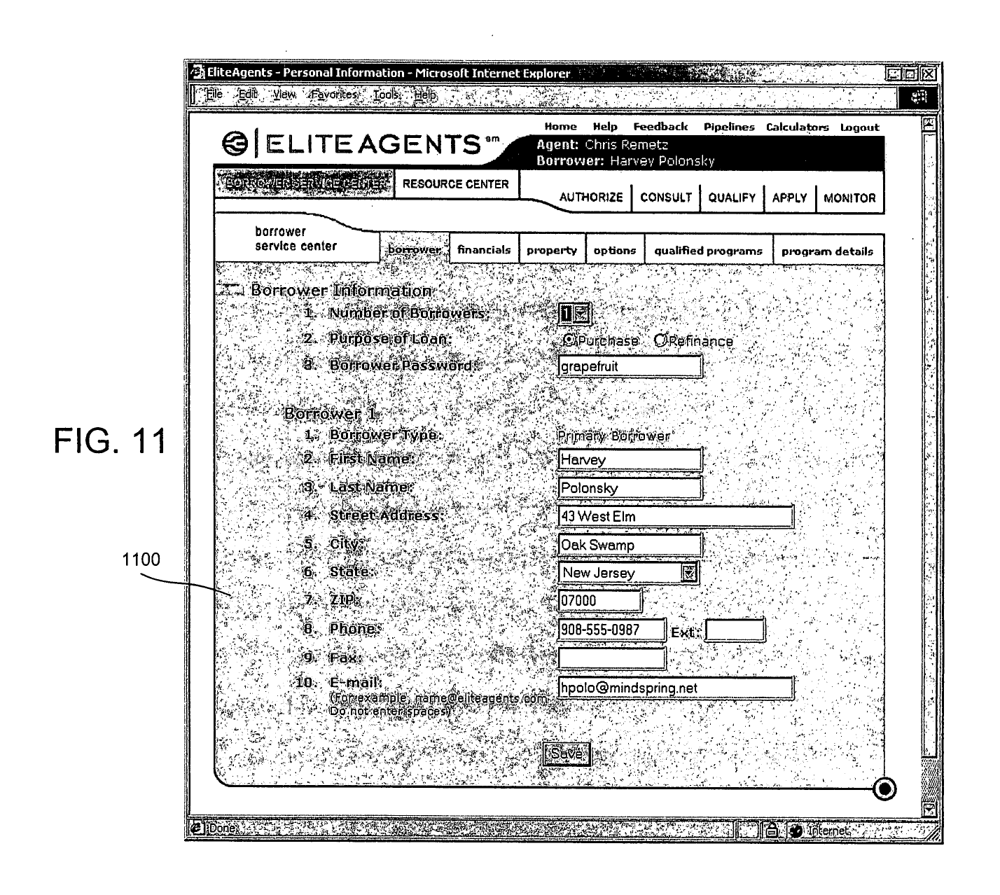

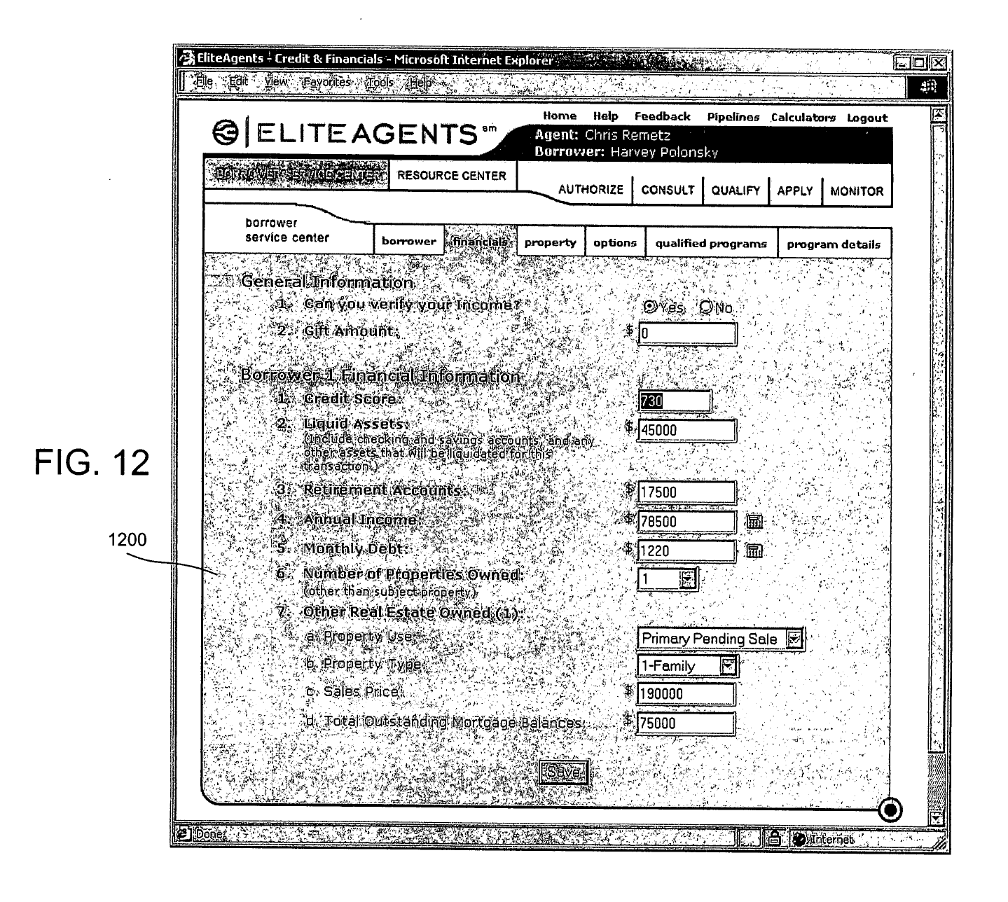

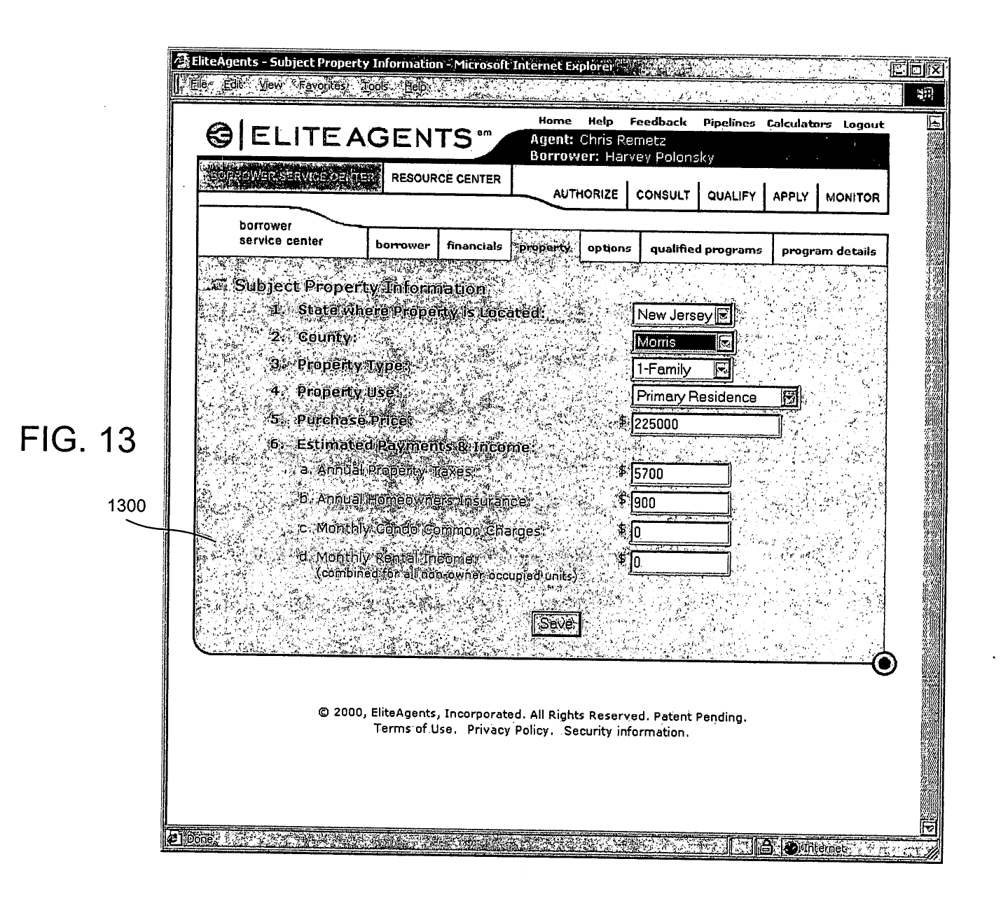

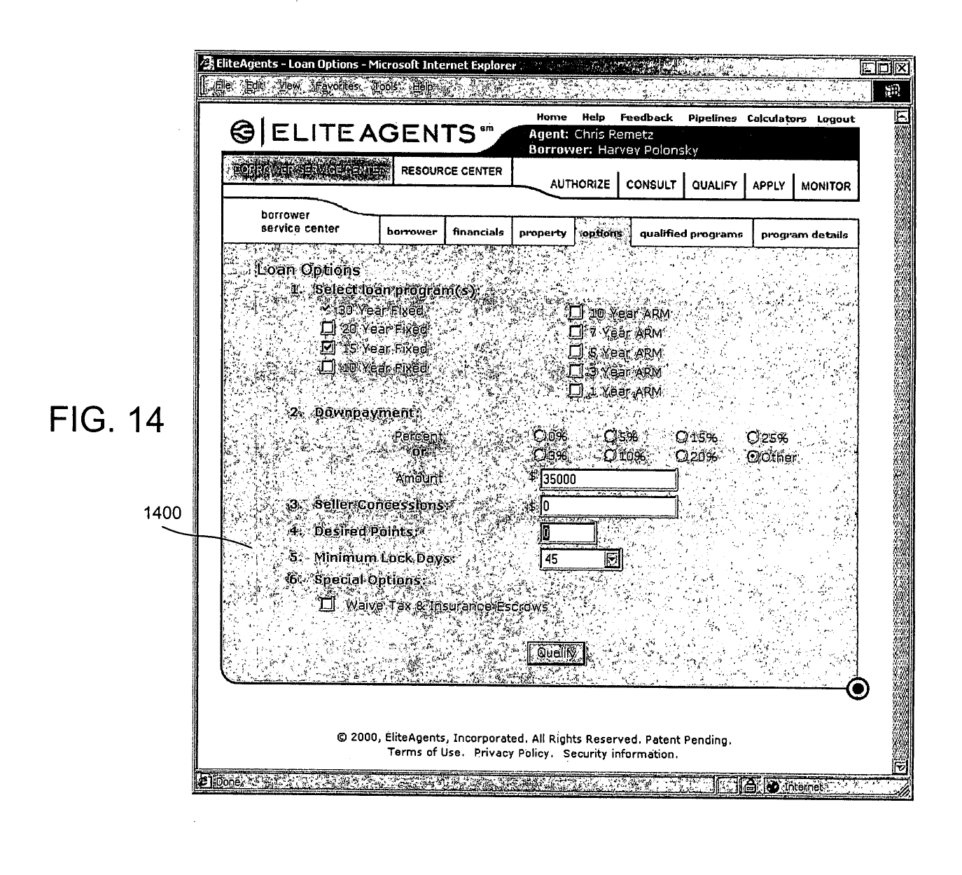

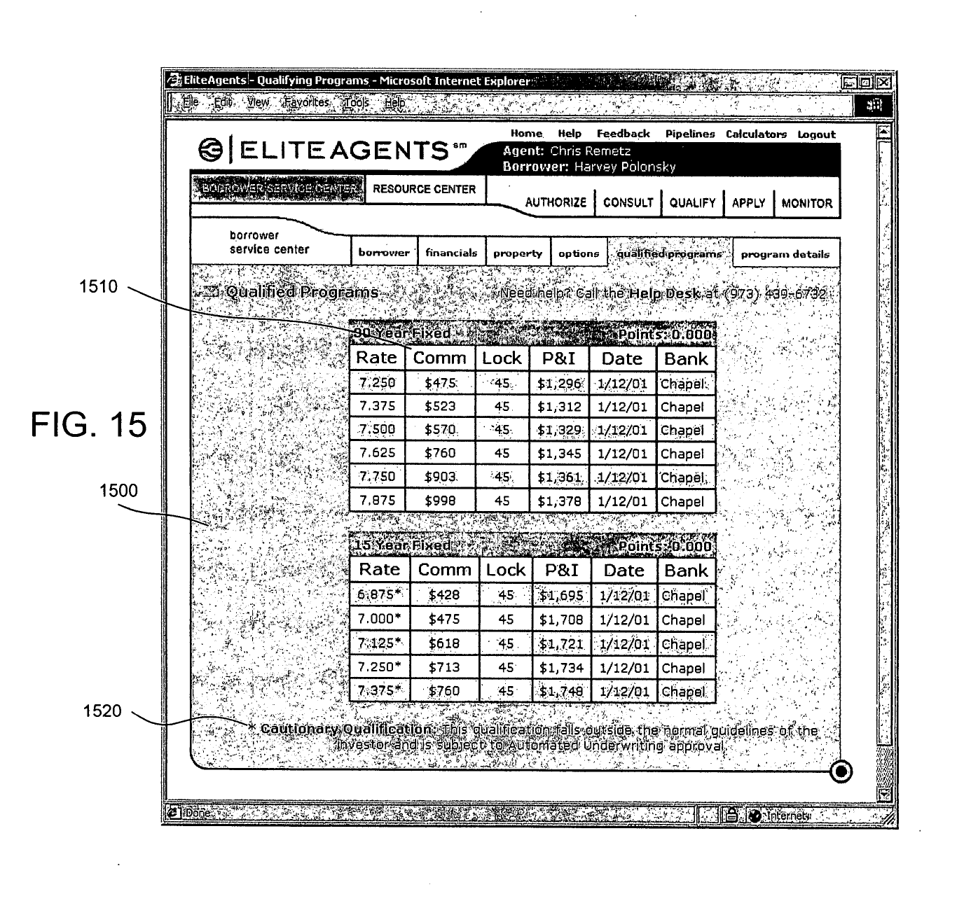

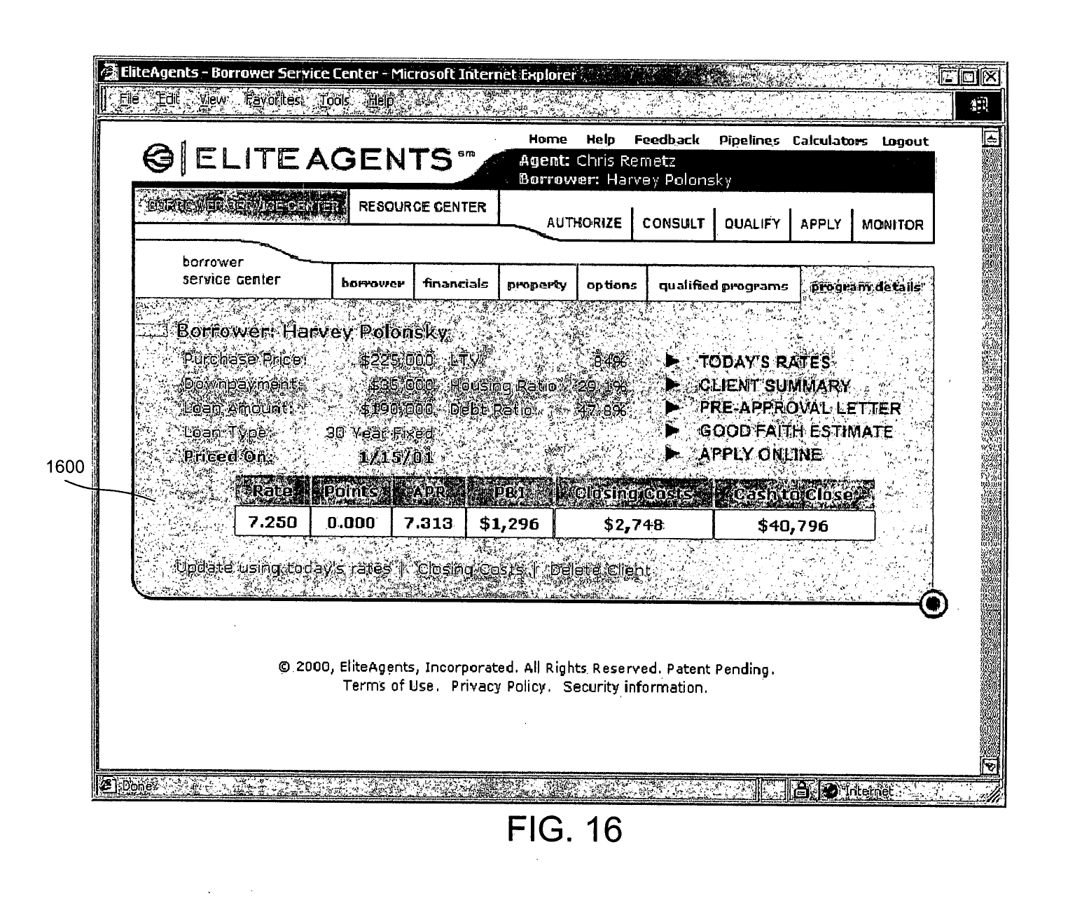

Pre-application mode consists of six separate steps that are designed to quickly guide a Realtor through the mortgage qualification process before actually applying for the mortgage. The six steps are based on dynamically obtaining the following information: Borrower Information (FIG. 11), Credit and Financial Information (FIG. 12), Property Information (FIG. 13), Program Loan Options (FIG. 14), Qualified Programs (FIG. 15), and Program Details (FIG. 16).

The borrower service center 320 is specifically designed to minimize the amount of information required to accurately qualify a borrower. The system streamlines the entry process to provide a qualified borrower with accurate mortgage programs and rates in real-time. This eliminates the normal waiting period necessary for a mortgage approval from a standard loan officer or mortgage bank. Once preliminary information from the qualification session has been entered and processed, the qualification processing engine 360 outputs a matrix of qualified programs, rates and commissions. One exemplary embodiment is illustrated in FIG. 15 on the “Qualifying Programs” page.

The qualification processing engine 360 operates under the premise that, within reason, there is a loan program for which everyone can be qualified. By emulating a loan officer's familiarity with, and understanding of, the universe of loan programs, the engine 360 is able to fit a proposed loan program to a specific qualification instance; even in cases outside of the traditional or conventional qualification guidelines. For example, it is clear to a loan officer that clients who can verify income, but have an inordinate amount of debt, may not qualify for a full documentation loan program. However, such clients could qualify, for instance, for a no-ratio loan program.

This apparently circular qualification analysis, based on the universe of all available loan programs, forms the basis of design for the qualification processing engine 360. The qualification processing engine 360 has four main processing stages: (1) compare borrower against database of loan products, (2) filter rates for each satisfied program, (3) choose the best program, and (4) present the final output. Technically these stages are not always processed sequentially in order to obtain final, qualified results.

To assist the Realtor in gathering accurate data, all mortgage and financial related entry fields have context-sensitive links into a help system. These links provide the Realtor with a specific description of what is expected to be entered at that field. Understanding that a borrower will only be qualified for an accurate mortgage based on accurate data input, the system has been designed to identify and trap as many errors as possible during the entry process and prior to the qualification process. For example, the system employs numerous data validation rules to ensure that entered data is accurate. In some cases, the data validation rule will have the Realtor confirm entered data that is out of the appropriate boundaries. In some cases the data validation rule will not proceed if required information has not been entered. Finally, before actually submitting the data for a mortgage qualification, the system will validate data relationships to ensure basic qualification rules. For example, if enough income has not been entered to cover the specified down payment, the Realtor will be alerted to this fact prior to qualification.

One embodiment of the borrower service center is illustrated in FIGS. 11 through 19 and FIG. 22 via exemplary screen shots where the “BORROWER SERVICE CENTER” Tab is highlighted on primary control bar of the user interface. Within this embodiment the borrower service center 320 data is entered into the Borrower, Financial, Property and Program information pages during a qualification session and processed by applications on the server and stored in the borrower service center database 330.

When a Realtor requests an on-line application on behalf of a borrower, data received during the qualification session is used to partially populate a secure online application form. The Realtor can edit or add to the information during the secure online application session 340. Upon submission of the secure online application, the data is automatically prepared for exportation to the processing center 180 via the borrower service center database 330 and the loan processing database 240.

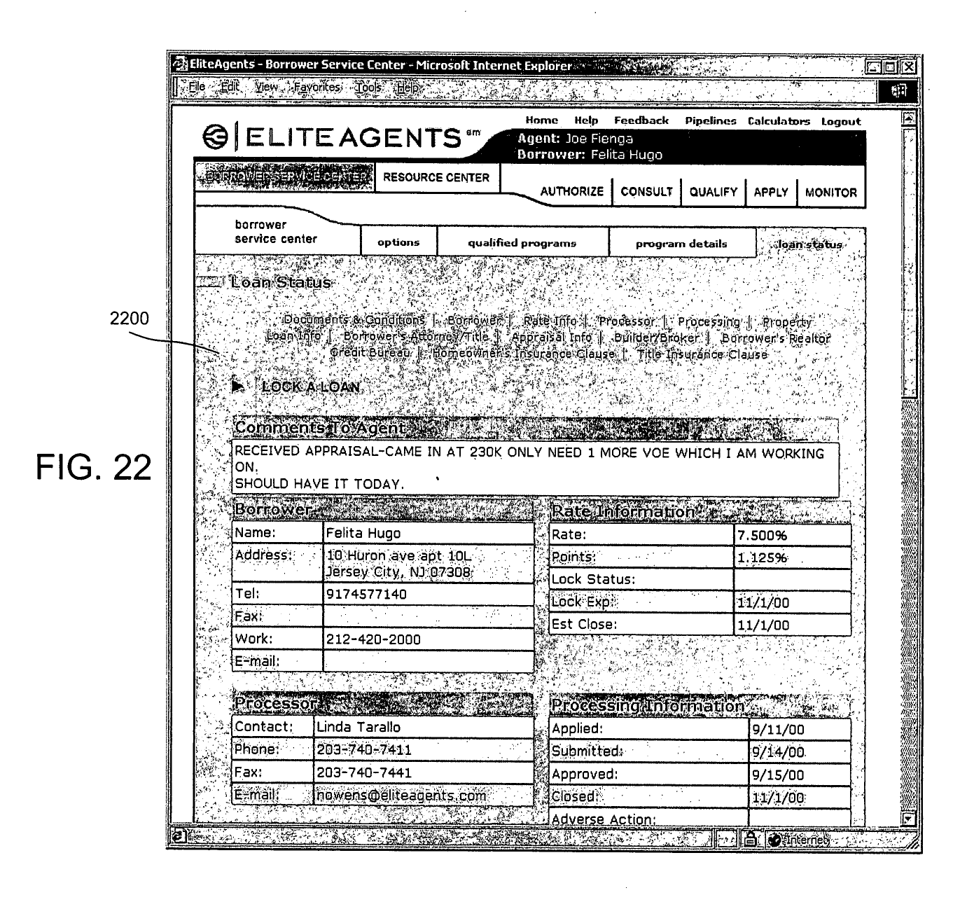

Once a mortgage application has been submitted for a qualified borrower, the borrower service center 320 enters a post-application mode for that borrower. In this mode, entry of qualification information is replaced with status functionality. After the loan processing application begins processing the secure online application that is stored in the loan processing database 240, updated information concerning the process is automatically forwarded to the borrower service center database 330 for status review via the loan status and pipeline monitor 350. In one embodiment, the following four screens may be available: Loan Options, Qualified Programs, Program Details, and Loan Status (FIG. 22).

Referring now to FIG. 4, there is a diagram illustrating a screen interface of an exemplary Login page 400. Due to the highly sensitive and personal nature of the information required when obtaining a mortgage, the borrower prefers for the information to be transmitted using encryption. In one embodiment, cipher strengths of at least 56-bit encryption are used to encode and decode all information transmitted between the Realtor terminal 105 and the mortgage origination system 140. In the illustrated embodiment, a user identification field 320 and encrypted password field 330 are used to help protect the system from unwanted access. Those skilled in the art will appreciate that the invention may be practiced with many types of security system configurations, including public key access (PKA), various tunneling protocols such as PPTP, and the like.

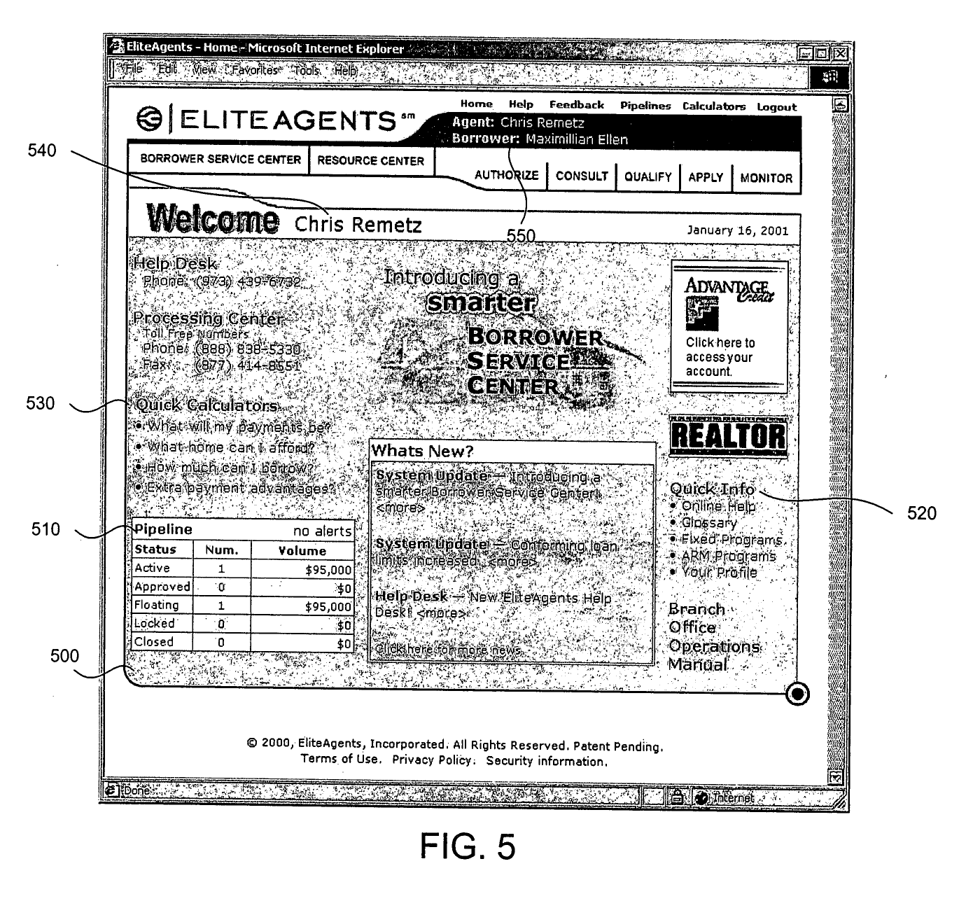

FIG. 5 is a screen interface of an exemplary system Home page 500 for use with the present invention. Typically, a home page is the first screen accessed and in the present invention, the home page is configured as a navigational aid or workstation for the Agent. The home page provides the communication starting point for a Realtor to begin or review application. One noticeable feature is the quick reference pipeline monitor 510 for all active, approved, floating, locked, and closed mortgage applications. The home page 500 also provides links to online help and other reference material under the Quick Info partition 520. The Quick Calculators 530 help determine various preliminary calculations, such as “What will my payments be?”, “How much can I borrow?”, “What home can I afford?”, and “Extra payment advantages?”. Personalization of the borrower service center page 500 can be accomplished on an individual basis according to the agent 540 or borrower 550.

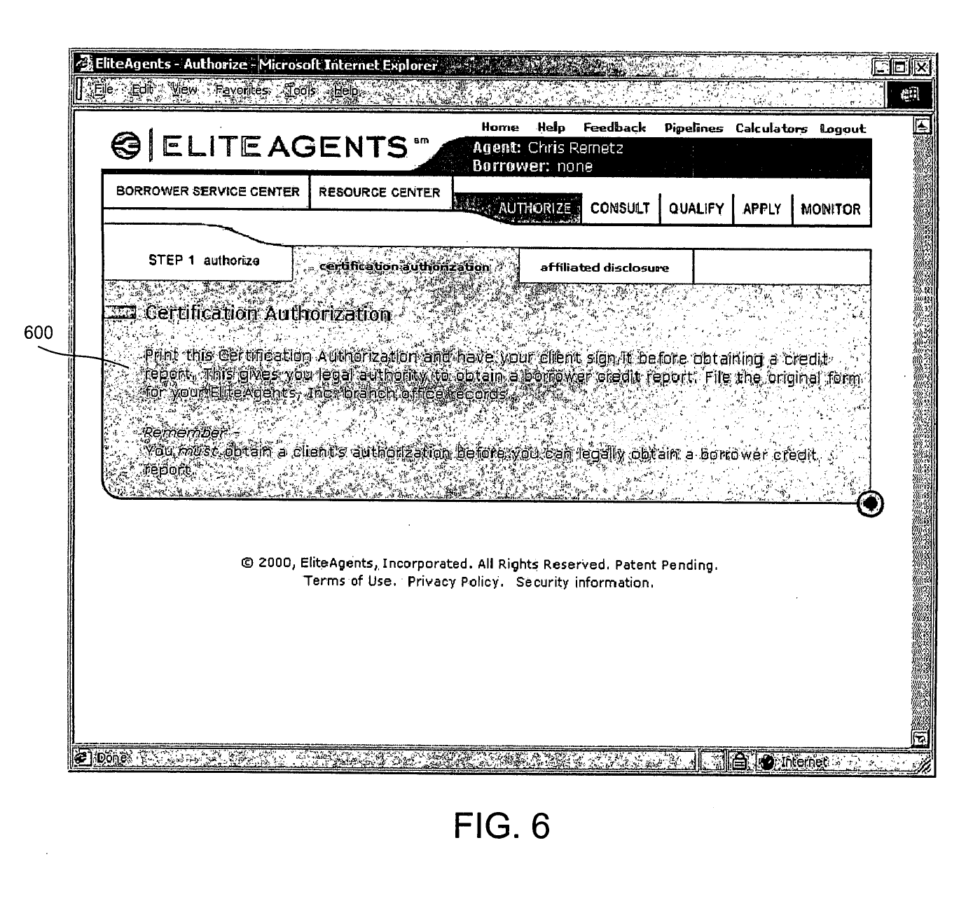

As shown in FIG. 6, a Realtor must certify the borrower's authorization to obtain a borrower credit report in preparation for origination of the mortgage. In the illustrated embodiment, the system provides printer ready authorization and disclosure forms required by federal and state regulations. The Realtor prints the forms, obtains the borrower's signature and faxes the forms to the processing center 180.

The illustrated authorize page 600 shows the tabs available during the Authorization step. Specifically, the step includes a “Certification Authorization” form and the state specific “Affiliated Disclosure” form. The version of the Affiliated Disclosure form defaults to a state specific form corresponding to the Realtor's state, but can be changed if the Realtor is acting as a solicitor for a different state. The illustrated page also informs the Realtor that this step is mandatory for RESPA compliance.

In an alternative embodiment, the certification authorization may be obtained electronically. For example, the Realtor may meet a prospective borrower at a remote location, such as an open house, and desire to provide counsel concerning available financing options for the real estate being offered. The borrower may provide an electronic signature to authorize a request for credit scores and the Realtor can via a wireless PDA connection obtain pre-authorization for the borrower. More importantly the Realtor has the entire mortgage origination system available to him at a remote location. The realtor can even check on the progress of other loan applications at the remote location.

Wireless connections and electronic signatures help reduce paper traffic between the borrower and Realtor. For example, electronic transmissions can allow necessary forms to be electronically transmitted to either the Realtor or the borrower, either at the point of access or to an electronic mail address. Once the borrower receives electronic transmissions containing the information in the printed forms of the previous embodiment, the borrower can review the materials and, if the terms are agreeable, provide a binding electronic signature to the Realtor to satisfy the regulatory requirements.

Upon completion of this authorization step, the Realtor is ready to move on to the second step, the borrower consultation. During borrower consultation, the Realtor assists the borrower in reviewing the home buying process; identifying available programs; and analyzing various “what if” mortgage qualification and payment scenarios with the borrower. Although the consultation process helps to ensure that the Realtor provides his or her client with superior service, aspects of the consultation ensure that the Realtor complies with RESPA guidelines.

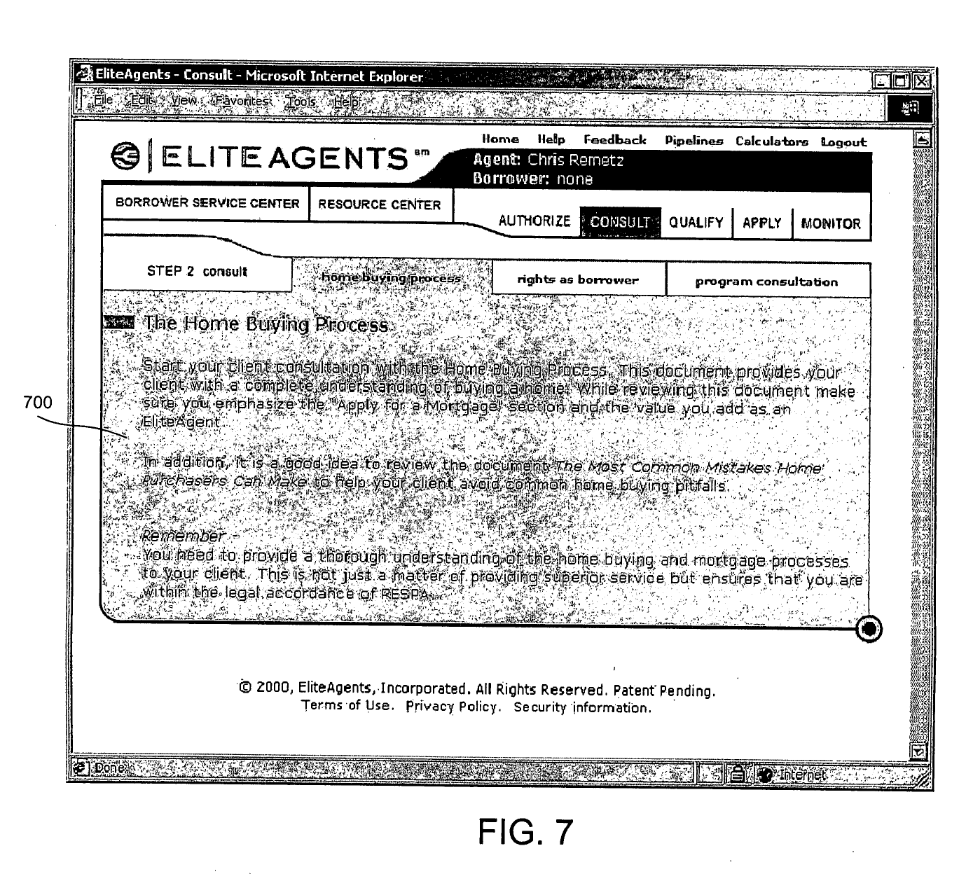

FIG. 7 is a screen shot of a “Consult” page 700 directed towards prompting the Realtor to explain the home buying process. This Figure illustrates the tabs available for the main consultation topics: The Home Buying Process; The Client's Rights as a Borrower; and Program Consultation. Each consultation topic is available as either an electronic file or a printed handout, which the Realtor can provide to the borrower during the consultation.

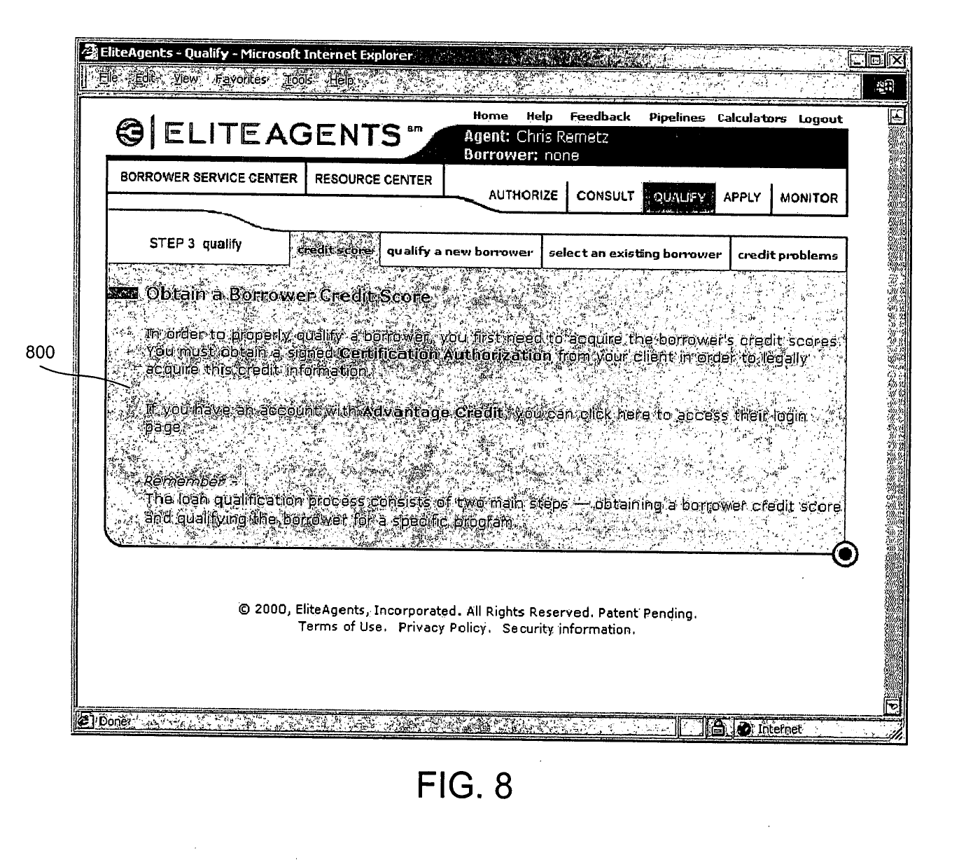

After a thorough consultation with the borrower, the Realtor can proceed to step three, qualifying the borrower for a specific mortgage program. FIG. 8 illustrates an exemplary screen instructional “Qualify” page 800 that prompts the Realtor on how to, “Obtain a Borrower Credit Score.” With the assistance of the various web pages found under within the qualify step, the Realtor is able to guide the borrower through accessing the borrower's credit information, managing possible credit problems, and qualifying the borrower for a specific mortgage program. Information input into the system during the previous steps helps develop a unique borrower file that is available through the entire process of the mortgage origination via the borrower service center database 330. Once the Realtor qualifies the borrower for a specific mortgage program, the information in the borrower file may be used to populate or fill out program specific forms, thereby minimizing the need for data re-entry during the online application process.

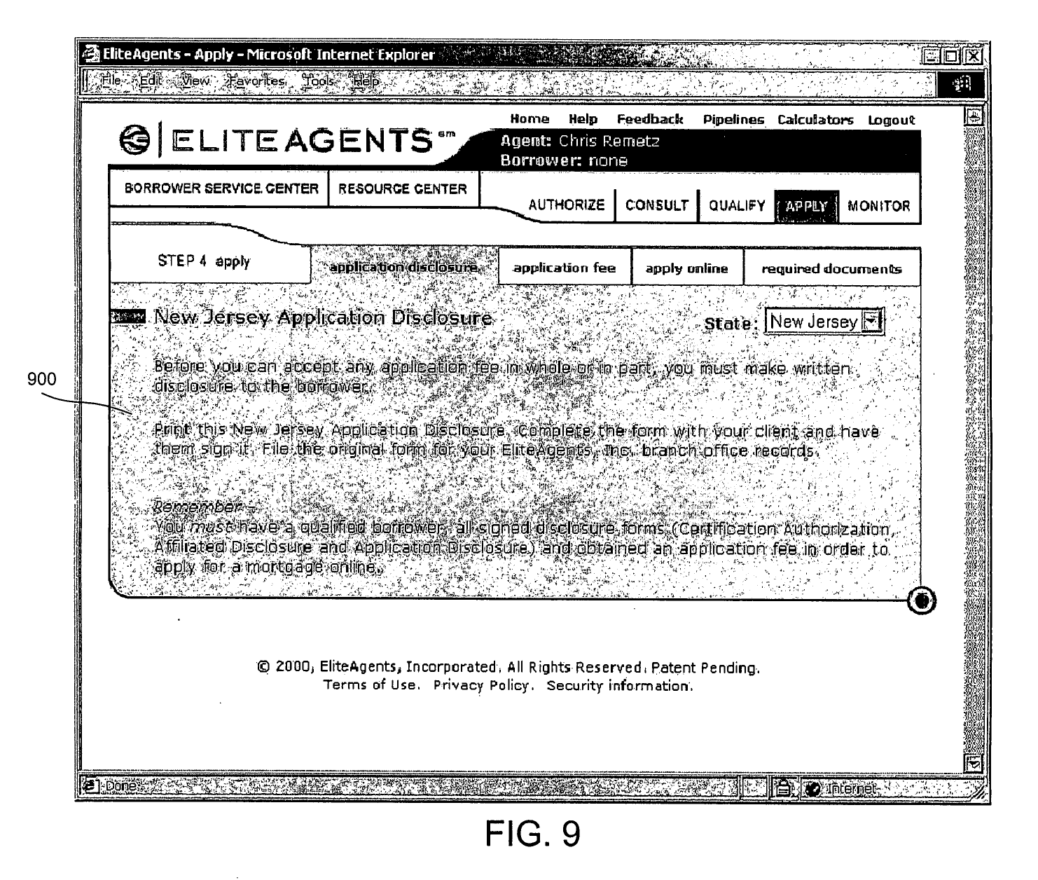

After the borrower has successfully qualified for a specific mortgage program, the Realtor can proceed to step four, e.g. preparing an online application for the borrower. During this step, the Realtor receives an application fee from a previously qualified borrower, enters an online application for mortgage processing and reviews a general list of documents required to obtain the mortgage. For example, the borrower prior to the Realtor receiving any application fees must sign a state-specific Application Disclosure. FIG. 9 is a screen shot of an exemplary application disclosure page 900 with a hyperlink to a New Jersey Application Disclosure form. As previously mentioned, the version of the application disclosure form defaults to the specific state of the Realtor, but can be changed if the Realtor is acting as a solicitor for a different state. Thereafter, the system electronically processes the submission of the application fee. Upon entry, the online application is electronically submitted to the processing center 180 for rapid approval and processing.

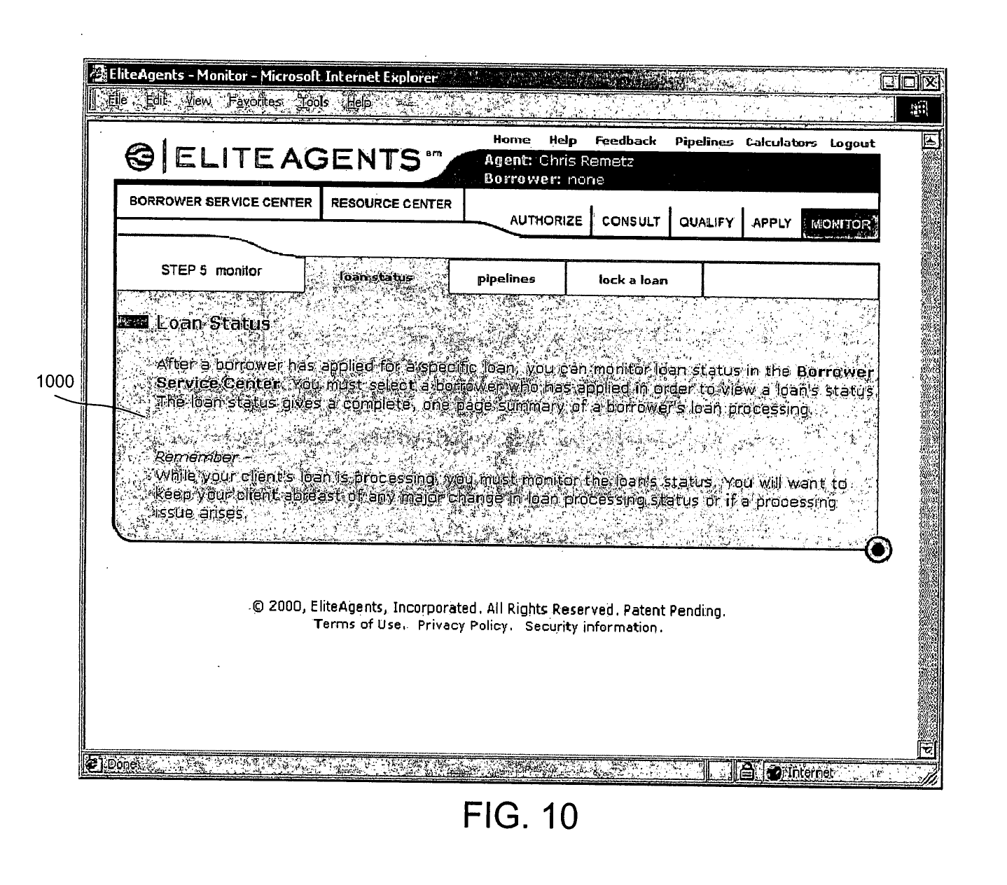

Once the borrower has submitted an online application, the Realtor proceeds to the final step of the five-step process and monitors the mortgage status. As shown in FIG. 10, an instructional “Monitor” page 1000 contains prompts. One prompt states that a Realtor must monitor a borrower's loan during the processing stages to pass on to the borrower any major change in the loan processing status, or if a processing issue arises. The system 140 further provides the tools that allow the Realtor to monitor the status of all their borrower loans throughout loan processing and underwriting. The mortgage status is monitored until the mortgage has closed. Monitoring includes checking on appraisal status, processor information, required documentation needed to approve a mortgage, and the conditions of the commitment to close the mortgage transaction. During this “monitor” step, the Realtor also assists the borrower in locking a rate for the mortgage prior to closing. In addition, commission-tracking information is available for the Realtor, based in part on the borrower loans being processed. Upon closing, the Realtor's mortgage origination tasks are complete and the Realtor is paid the commission associated with the mortgage origination.

The first data collected in the qualification and application process for a borrower is basic borrower information. This creates a borrower file that is then accessible throughout the origination process. FIG. 11 is a screen shot of an exemplary “personal Information” page containing borrower information. The borrower information page 1100 serves two functions. First, it acquires basic items that dynamically govern what qualification information must be acquired. For example, the number of borrowers specifies whether a co-borrower is associated with the mortgage. Additionally, the purpose of the loan field specifies either a home purchase or refinance. The second function is the acquisition of basic identification information for each borrower. The password field is used to allow the borrower remote access to the status of his or her mortgage.

Upon completion of the borrower information page 1100, the Realtor automatically proceeds to the second step of the. qualification process, the borrower financial information page 1200. FIG. 12 is a screen shot of an exemplary dynamic borrower financial information page 1200. Information about the borrower's financial status provides the basis for the income qualification for the mortgage. FIG. 12 illustrates the general financial information required to complete this form, including; credit score, liquid assets, annual income, and monthly debt. Separate income and debt calculators can be accessed to help acquire specific income and obligation information. Identifying whether the borrower owns other real estate can have a profound impact on that borrower's income and debt. The system identifies exactly the number and the type of other real estate owned. In addition, it obtains only the required financial information necessary in the mortgage origination process.

Upon completion of the borrower financial information page 1200, the Realtor automatically proceeds to the third step of the qualification process, the property information page 1300. FIG. 13 is a screen shot of an exemplary property information page 1300. The information submitted on this page is specific to the property being purchased or refinanced. For example, information about additional payments and income relating to the property are requested, such as all annual taxes, fees, and insurance.

Upon completion of the property information page 1300, the Realtor automatically proceeds to the fourth step of the qualification process, the loan options page 1400. FIG. 14 illustrates an exemplary loan options page 1400. This page allows the Realtor to specify the mortgage type, term, down payment, and desired points that the borrower is seeking. Choosing several different loan programs at once for qualification allows the system to compare and filter a variety of available mortgage programs.

Upon submission of the loan options page 1400, all the information required for a pre-qualification has been provided. At this point, the system, using information submitted in the previous four steps, queries the mortgage program database for a list of programs, which meet the qualification criteria. Results of the query may be automatically stored in the borrower service center database 330 for presentation in a qualified loan program list.

FIG. 15 is a screen shot of an exemplary qualified programs page 1500 containing two tables of loans for which the borrower, Harvey Polonsky, is qualified. The qualified programs page 1500 provides a list of the specific mortgage programs for which the borrower has qualified based on the information previously provided to the borrower service center 320. For each qualified program, a matrix is displayed with a range of available rates and associated origination commissions 1510. From this list of qualified programs, the Realtor can determine the rate quote to offer the borrower. The Realtor then selects the loan program to offer the borrower. This selection is based on the program type and term, the appropriate rate and the desired commission the Realtor would like to earn.

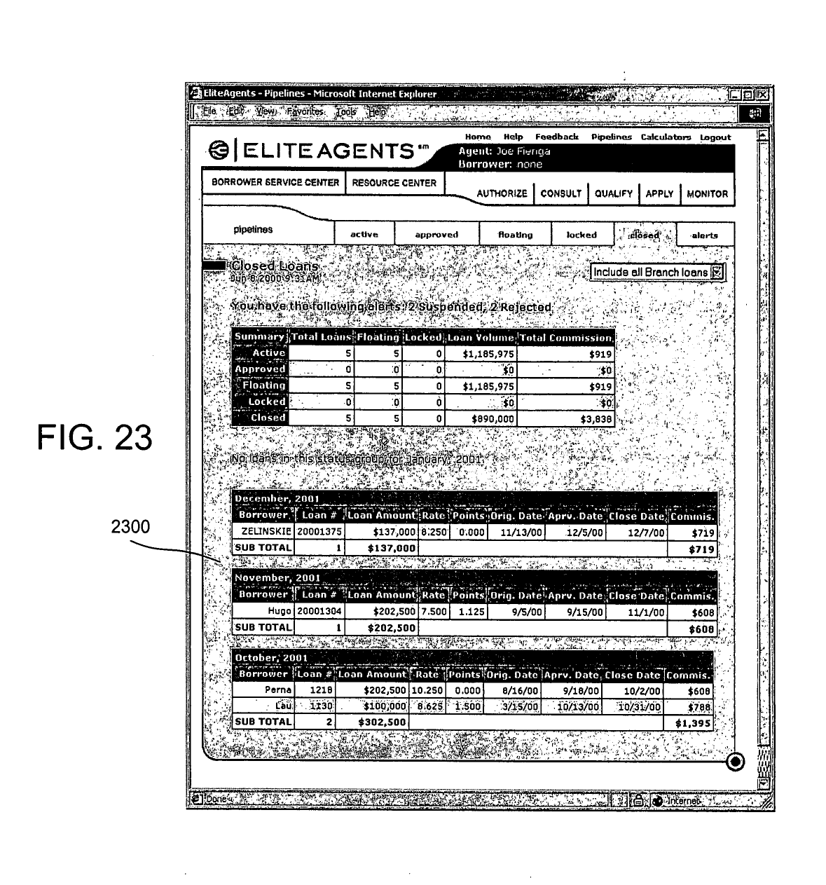

In one embodiment, the system provides options on how to display commissions on this page. For example, a Realtor can opt for a minimum commission amount and can opt to eliminate the commissions from being displayed on this page altogether. In any case, if the commission calculated is below the specified minimum commission amount, the system will display a visual indicator. For example, the system may display an entire row of the loan program table in a different color, such as bright red, or the system may use some other easily recognizable designation, such as flashing or animation. The visual indicator alerts the Realtor that the offered loan program, although qualified for the borrower, provides a commission that is below the desired minimum. Commission calculation and information are discussed in greater detail in FIG. 23.

In a preferred embodiment, the system provides a commission filter that can identify and/or filter the qualified loan programs that are below a desired minimum commission (or commission rate). The user may opt to display these qualified loan programs identified by the commission filter with a different visual indicator from the qualified loan programs having at least the desired minimum commission. For example, the qualified loan programs with at least the desired minimum commission are displayed in a green color, while the qualified loan programs with less than the desired minimum commission are displayed in a red color. Preferably, the user can selectively eliminate some or all of the qualified loan programs having less than the desired minimum commission from the display, e.g., before forwarding the display to the borrower, so that these qualified loan programs will not be recommended to the borrower. Alternatively, the commission filter may simply filter all the qualified loan programs that have a commission below the desired minimum commission so that a user will only receive the qualified loan programs that have at least the desired minimum commission.

Preferably, the system can work with multiple loan providers or mortgage banks so as to obtain qualified loan programs from different lenders, which usually offer different commissions. Preferably, the user can opt to display the list of qualified loan programs in a descending order of commissions, or opt to display the list of qualified loan programs in an ascending order of rates before forwarding the list to the borrower, preferably after eliminating the qualified loan programs that have commissions less than the desired minimum commission as explained above.

In some cases, a borrower may not qualify for a program based on specific lender guidelines, but still qualifies for the program based on the risk-based, assumed guidelines s of automated underwriting. In this case, the borrower will qualify for a cautionary qualification 1520, which allows the borrower to apply for the loan but does not provide a real-time pre-approval letter. The qualification processing engine outputs the cautionary qualification based on previous “approval” experience with applications that should have been “denied” under the published lender guidelines, but that were approved using the automated guidelines. Thus the lenders do not specify the guidelines of automated underwriting, but these guidelines may be derived from operational experience in qualifying borrowers using the various automated underwriting engines, such as Fannie Mae and Freddi Mac. As such a cautionary qualification is an “estimate” that the application would be approved based on other applicants with similar loan application information.

If the borrower does not qualify for any mortgage programs based on the entered qualification information, the system will reject the borrower and display the reason for the rejection. At this point the Realtor can try to adjust the qualification information based on the reasons for rejection and re-submit the borrower for qualification. The Realtor can also apply for a credit mortgage approval without a qualified program. In this case, a mortgage application is still submitted to the processing center 180 for manual approval.

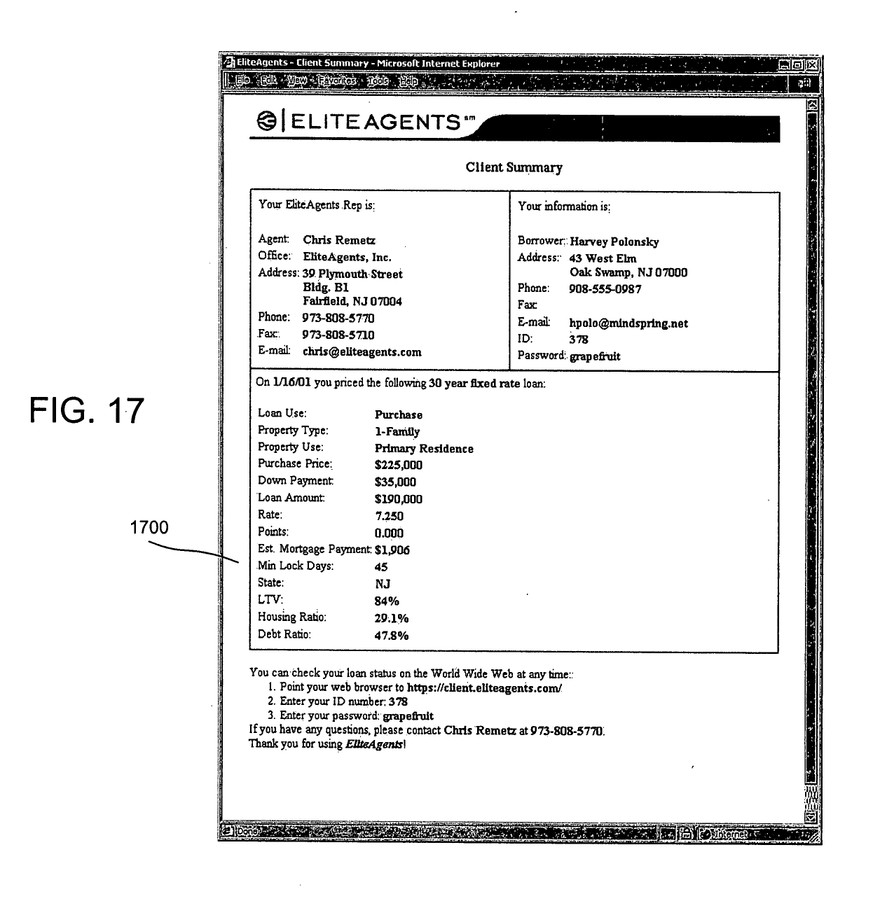

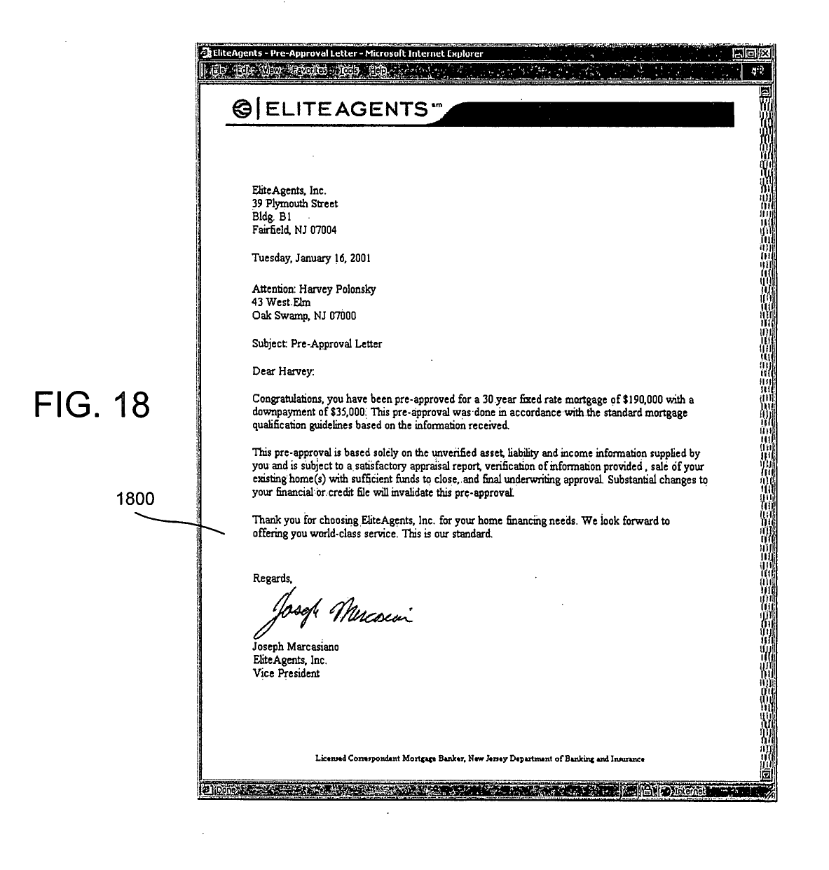

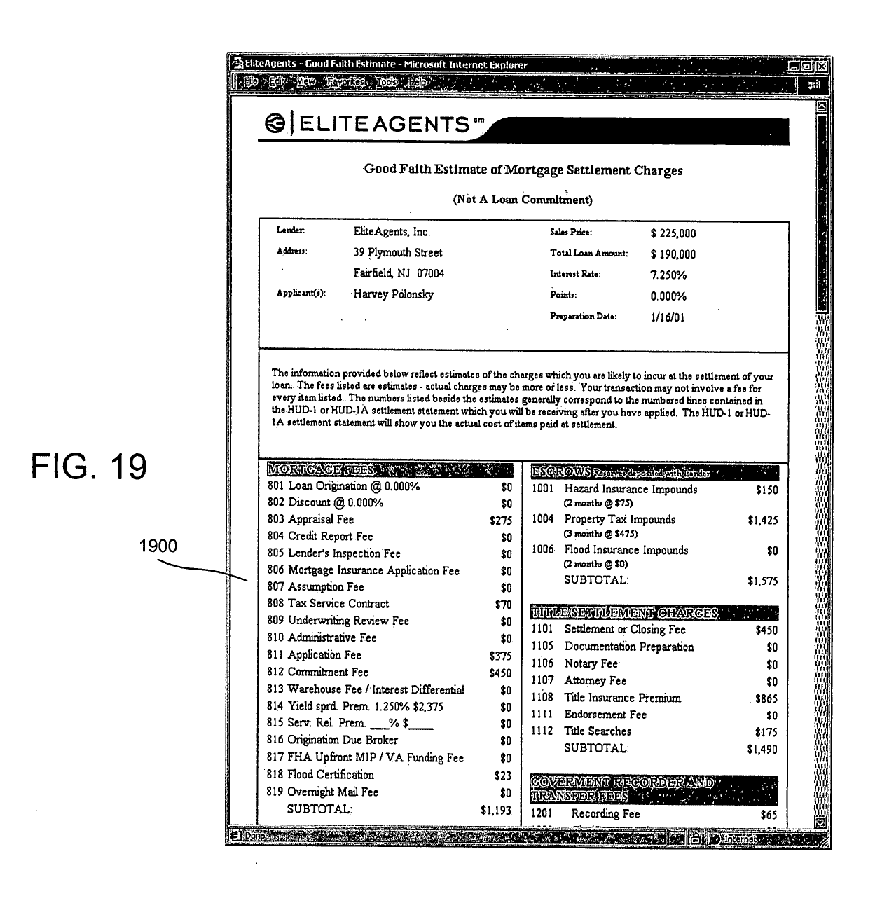

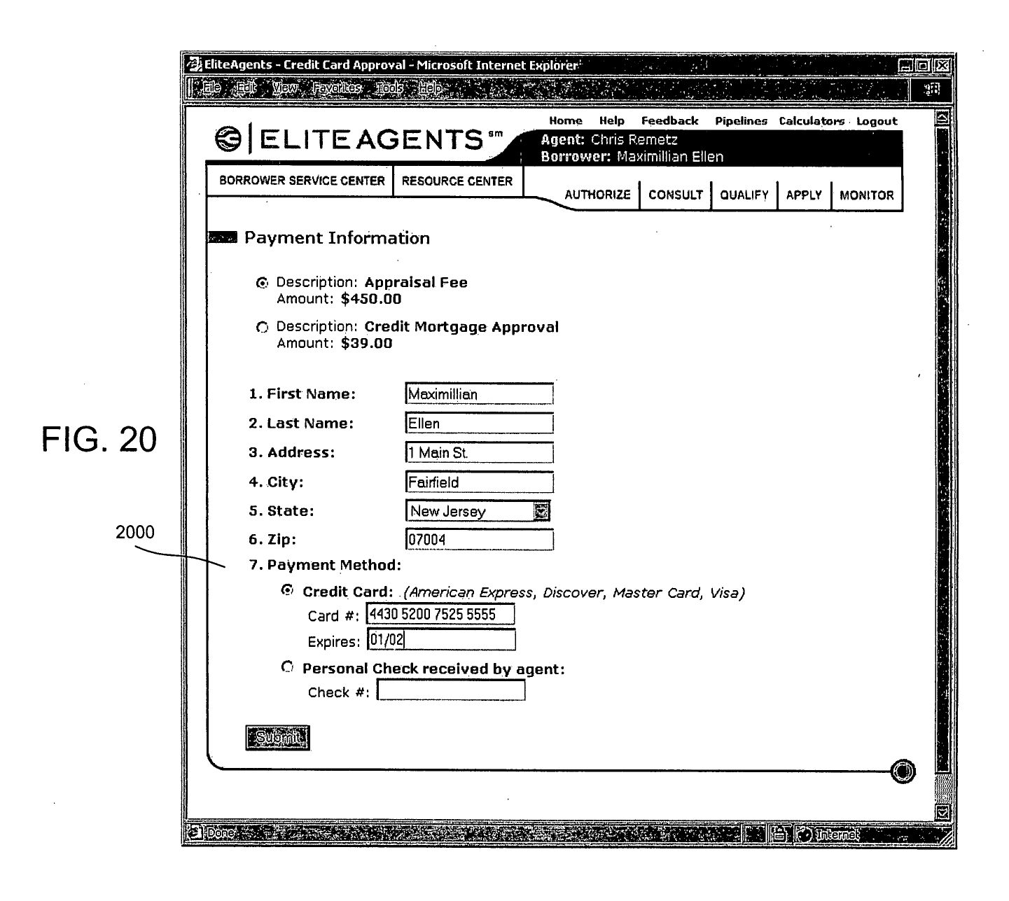

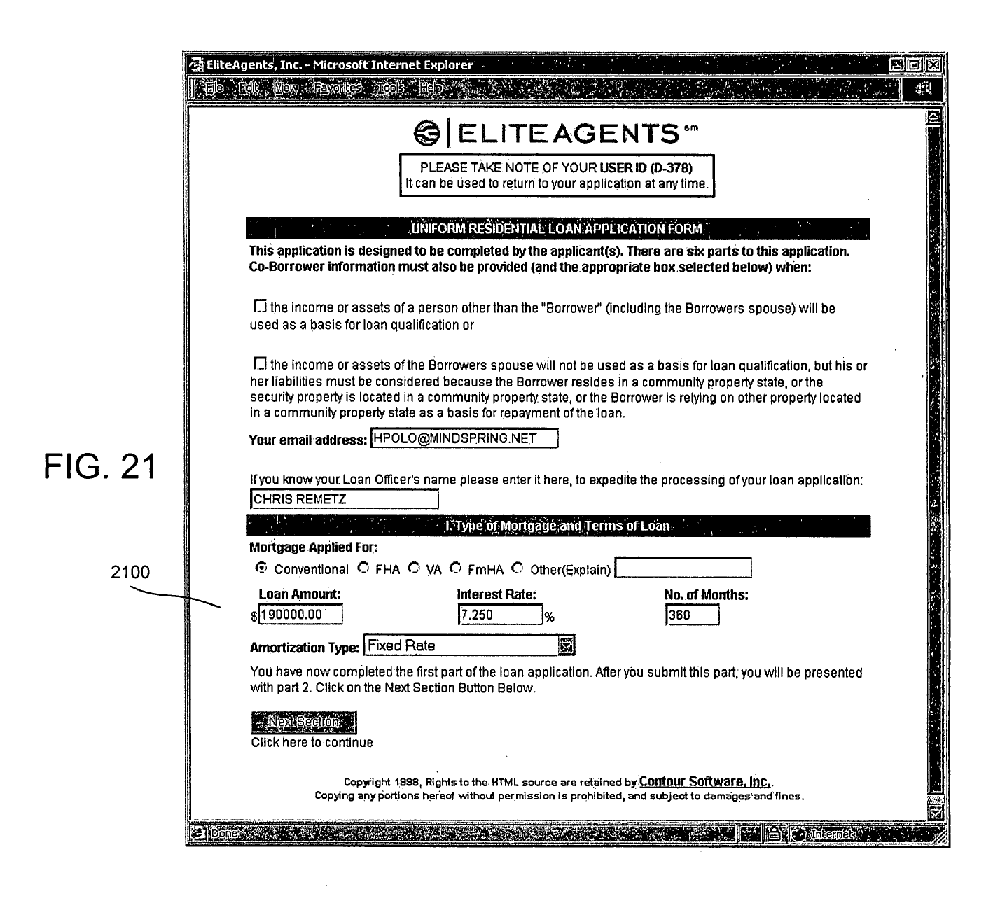

Once the specific program is selected the system will automatically proceed to a program details page, the final step in the qualification process. FIG. 16 is a screen shot of an exemplary loan program details page 1600. The program details page 1600 provides a detailed description of the terms of the qualified mortgage that have been selected for the borrower. It is also a hub screen containing links from which several functions can be performed specific to a qualified borrower. These functions include: updating the qualified information with “Today's Rates”, providing the borrower with a printed “Client Summary” of the qualified mortgage program (FIG. 17), providing the borrower with a printed “Pre-approval Letter” (FIG. 18), providing the borrower with a printed “Good Faith Estimate” (FIG. 19), and proceeding to “Apply Online” for a qualified program. This includes automatic submission of processing fees (FIG. 20) as well as completing a full online application for the borrower (FIG. 21).

These functions are all preferably available in real-time. That means that the Realtor can provide a Pre-approval Letter 1800 or a Good Faith Estimate 1900 immediately upon qualifying a borrower. A desirable function that is available at the program details page 1600 is the ability to “Apply Online” by electronically submitting the borrower's mortgage application for processing via the secure online application 340.

As is shown in FIG. 17, a screen shot of an exemplary client summary page 1700, the client summary page 1700 is a quick snapshot of the details associated with the program for which the borrower qualified. The Realtor may use it as a handout for the borrower, as this page includes important instructions and password information for remote access by the borrower to their loan status.

If a borrower qualifies for a specific mortgage program, a pre-approval letter 1800 is available immediately. FIG. 18 is a screen shot of an exemplary pre-approval letter page 1800. While this letter is not a commitment for a mortgage, it indicates that a borrower should be able to obtain a mortgage if the information provided by the borrower is accurate and true. To receive a credit mortgage approval or a mortgage commitment, the borrower will require final verification of income and assets, a full credit report and a home appraisal. This can only be accomplished by submitting a complete online application.

If a borrower qualifies for a specific mortgage program, the good faith estimate is also available immediately. FIG. 19 is a screen shot of an exemplary good faith estimate page 1900. The good faith estimate page 1900 is a printable report to be given to the borrower outlining the potential costs associated with a mortgage loan. This page 1900 is only an estimate of the expenses associated with a mortgage loan, such as the mortgage fees, settlement charges, escrows and prepaid costs. Some of the figures on a good faith estimate 1900 are accurate, such as the mortgage fees, and some are only estimates of possible expenses such as title or settlement expenses.

The mortgage origination system 140 of the present invention also has the functionality to automatically receive and track fees. Prior to submitting an application online, the Realtor must supply a confirmation of payment using the payment information page 2000 as illustrated in FIG. 20. Fee amounts are automatically calculated and presented on this page. This page can either collect the fee automatically via a credit card or track a personal check that the Realtor has received from the borrower.

After confirmation of payment of application fees, the system provides for the online entry of the full “1003 Uniform Residential Mortgage Loan Application Form” (URMLA) or its equivalent. This process consists of several data entry screens, which preferably mimic the paper version of the URMLA or equivalent. FIG. 21 is a screen shot of the first screen of the exemplary online Uniform Residential Loan Application page 2100. Fortunately, if similar information was entered in the borrower service center 320 during the qualification process it is automatically carried forward into the online URMLA or equivalent pages as defaults. Upon completion, the online application is electronically submitted to the processing center 180.

A loan status page 2200 provides the Realtor and the borrower with up-to-date information about the status of the mortgage being processed. FIG. 22 is a screen shot of an exemplary loan status page 2200. This status page 2200 includes borrower, processor, rate, and other information associated with the loan application process.

The Pipeline Monitor section of the system is not directly tied to the borrower service center 320 but is dependant on post-application functionality. FIG. 23 is a screen shot of an exemplary closed loan pipeline page 2300. The closed loan pipeline page 2300 provides the Realtor with alert prompts for suspended and rejected applications. It also provides historical information sorted by month, year, and borrower regarding previously closed loans and their corresponding terms. The closed loan terms include (1) commission, (2) borrower, (3) loan number, (4) loan amount, (5) rate, (6) points, (7) origination date, (8) approval date, and (9) close date. The monitor section provides status and commission information on all of a Realtor's loans that are being processed. Significantly, the pipeline tab allows a Realtor to track multiple loan originations in one location. The system also will track the relationship of a branch manager, or broker, with the real estate agents, or solicitors, who work for that branch manager. In the case of a branch manager, the monitor section of the system can provide loan status information for loans originated by the managed solicitors as well as the branch manager.

The present invention also implements a data scheme capable of supporting multiple levels of commission calculations. For example, a total commission is calculated based on the total loan amount. This total commission may be subdivided for distribution as a branch commission, solicitor commission, and manager commission. In one embodiment, the branch commission is a fractional percentage of the total commission and is divided into the solicitor and manager commissions. For example, the branch earns 40% of the total commission, with half of the branch commission or 20% of the total commission going to the originating agent as a solicitor commission and the remaining 20% of the total commission going to the branch manager as a manager commission. As such the pipeline monitor of the manager would also track the origination efforts of the agents working with the branch. In an alternative embodiment, a large branch could have multiple managers and multiple solicitors.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by U.S. Letters Patent is:

1-46. (canceled)

47. An interactive mortgage origination system for business-to-business use via selected point-of-access professionals, the system comprising:
a borrower service center for receiving loan application information pertaining to a potential borrower into a database and for receiving a loan approval status;
a qualification processing engine that receives the loan application information from the database and outputs a plurality of qualified loan programs to the database, each loan program comprising rate and commission information; and
a remote access terminal in communication with the borrower service center, the terminal displaying qualified loan programs including the rate and commission information associated with each loan program, the terminal comprising means providing an option for a Realtor not to display a qualified loan program that has a commission below a predetermined minimum commission.

48. The system as recited in claim 35, wherein the means for providing the option is operable by the Realtor to selectively eliminate said qualified loan program that has the commission below the predetermined minimum commission.

49. In a computer based mortgage origination system, a method for Realtor-assisted loan shopping and origination, comprising:
receiving from a Realtor information about a borrower;
transmitting to the Realtor a list of loan programs for which the borrower is qualified, wherein the list of qualified loan programs includes a range of interest rates and a range of commissions associated with listed loan programs, wherein the list further indicates when a qualified loan program provides a commission lower than a pre-selected minimum commission;
receiving a loan application from the Realtor on behalf of the borrower for a loan program selected from the qualified loan program list; and
selectively eliminating a qualified loan program having a commission lower than a pre-selected minimum commission.

50. In a computer based mortgage origination system, a method for Realtor-assisted loan shopping and origination, comprising:
receiving from a Realtor information about a borrower;
transmitting to the Realtor a list of loan programs for which the borrower is qualified, wherein the list of qualified loan programs includes a range of interest rates and a range of commissions associated with listed loan programs;
receiving a loan application from the Realtor on behalf of the borrower for a loan program selected from the qualified loan program list; and
selectively eliminating a qualified loan program having a commission lower than a pre-selected minimum commission.

51. In a computer based mortgage origination system, a method for Realtor-assisted loan shopping and origination, comprising:
receiving from a Realtor information about a borrower;
transmitting to the Realtor a list of loan programs for which the borrower is qualified, wherein the list of qualified loan programs includes a range of interest rates and a range of commissions associated with listed loan programs;
receiving a loan application from the Realtor on behalf of the borrower for a loan program selected from the qualified loan program list; and
filtering qualified loan programs having a commission lower than a pre-selected minimum commission from being transmitted to the Realtor.

52. A method for originating a loan for a borrower, the method comprising:
prompting a Realtor concerning loan origination for a borrower;
qualifying the borrower for at least one loan program;
obtaining a list of qualified loan programs, each qualified loan program including a rate and a commission;
presenting at least one qualified loan program to the borrower;
applying on behalf of the borrower for one qualified loan program to procure a loan application; and
monitoring status of the loan application and commission pipeline; wherein said qualifying comprises
acquiring borrower credit scores;
qualifying a borrower application for a specific loan program based in part on acquired borrower credit scores; and
returning a list of qualified loan programs and respective loan information, wherein the loan information comprises term, points, associated interest rate, and commission rate, and wherein the list contains loan programs having at least a minimum commission amount.

53. The method as recited in claim 52, wherein the list of qualified loan programs includes a visual indicator for loan programs that provide a commission that is below the desired minimum commission, the method further comprising:
optionally eliminating the qualified programs as indicated by the visual indicator to have the commission below the desired minimum commission.

51. In a computer based mortgage origination system, a method for Realtor-assisted loan shopping and origination, comprising:
receiving from a Realtor information about a borrower;
transmitting to the Realtor a list of loan programs for which the borrower is qualified, wherein the list of qualified loan programs includes a range of interest rates and a range of commissions associated with listed loan programs;
receiving a loan application from the Realtor on behalf of the borrower for a loan program selected from the qualified loan program list; and
filtering qualified loan programs having a commission lower than a pre-selected minimum commission from being transmitted to the Realtor.

54. A qualification processing apparatus, the apparatus comprising:
an input for receiving borrower data;
a database of loan products;
a comparison module for evaluating the borrower data against all loan products in the database and generating a list of all loan programs to which the borrower qualifies;
a rate filter for receiving the list of qualified loan programs, the rate filter comparing the list to investor and proprietary guidelines and generating a rate matrix for each qualified loan program; and
a commission filter for receiving the rate matrix and filtering the rate matrix for commissions that are outside of minimum commission guidelines comprising a desired minimum commission, the commission filter generating a list of qualified loan programs.

55. The apparatus as recited in claim 54, wherein the list of qualified loan programs generated by the commission filter comprises a visual indicator for qualified loan programs that have a commission outside of the minimum commission guidelines.

56. The apparatus as recited in claim 55, further comprising an option to eliminate the qualified loan programs indicated by the visual indicator from the list.

57. The apparatus as recited in claim 54, wherein the list of qualified loan programs generated by the commission filter does not include qualified loan programs that are outside of the minimum commission guidelines.

58. The apparatus as recited in claim 54, wherein the list of qualified loan programs generated by the commission filter comprises a visual indicator for qualified loan programs that have a commission outside of the minimum commission guidelines.
